(19) United States
(12) Patent Application Publication
(10) Pub. No.: US 2007/0244764 A1
(43) Pub. Date: Oct. 18, 2007

(54) Method and apparatus for customizing items

(76) Inventor: Sandra Kay Pryor, Hendersonville, NC (US)

Correspondence Address: DORITY & MANNING, P.A., POST OFFICE BOX 1449, GREENVILLE, SC, 29602-1449, US

(21) Appl. No.: 11/405,314

(22) Filed: Apr. 17, 2006

(51) Int. Cl. G06Q 30/00

(52) U.S. Cl. 705/26

(57) ABSTRACT

The present invention discloses and claims a method and apparatus for customizing items. The method may include selling a key code and receiving the key code along with a graphical image and delivery information. The method may further include validating the key code, weaving the graphical image into a product to create the customized woven item, and delivering the customized woven item in accordance with the delivery information. The apparatus may include a customized item having a container, a key code associated with the container, and instructions for submitting the key code along with a graphical image to a manufacturer for transferring the graphical image to a product to create the customized item.

### FIELD OF THE INVENTION

The present subject matter relates to customizing items. More particularly, the present subject matter relates to a method and apparatus for giving a selectively customized woven or canvas product to a recipient.

### BACKGROUND OF THE INVENTION

The practice of gift giving is a time honored tradition that is practiced worldwide. Individual gift items may be as varied as the occasions for which they may be selected and may vary over a wide range of prices. A particularly vexing problem arising out of the desire to give a gift regardless of the occasion relates to gift selection, most especially when one wishes to give a personal or customized item possibly reflecting specific interests that may be held by the recipient.

Various types of purchasing opportunities are presented to the consumer daily from shopping malls to catalog sales and online purchasing. In some instances items may be customized through application of specific graphical or pictorial representations. U.S. Pat. No. 6,992,787 (Fredlund et al.) discloses a method of purchasing image bearing products. The method involves the establishment of a number of network connected kiosks at plural remote locations. The system allows a user to notify another person that a prepaid picture is available for them and that they may retrieve the picture by visiting any of the network- connected kiosks where they may have the picture printed out.

Another example of a customized image bearing item and system can be found in U.S. Pat. No. 6,004,018 (Kawasato et al.), which concerns a device for producing embroidery data on the basis of image data. Kawasato et al.'s apparatus and methodology correspond to a system and method wherein an image may be scanned or produced using a computer aided design (CAD) program and then used to control a sewing machine to recreate the image as an embroidery pattern.

U.S. Pat. No. 5,966,454 (Thomas et al.) relates to methods and systems for manipulation of images of floor coverings or other fabrics. Thomas et al. maintains a digital library of fabric models for floor coverings, wall coverings, and interior design treatment that may be further manipulated and then used to generate samples of carpet or other material on interest.

U.S. Pat. No. 5,058,174 (Carroll) discloses a system and method for generating a pattern from an image. A predefined image may be scanned with a video camera and then processed by converting various color portions of the image to a forty-eight (48) color pallet. The processed information may then be used to create a hook rug pattern.

While various methodologies have been developed to provide customized individual gift items and while various implementations of customized image producing systems and methods have been developed, no design has emerged that generally encompasses all of the desired characteristics as hereafter presented in accordance with the present subject matter.

### SUMMARY OF THE INVENTION

Objects and advantages of the invention are set forth below in the following description, or may be obvious from the description, or may be learned through practice of the invention.

The present invention provides a method for providing a customized woven item. The method includes selling a key code and receiving the key code, a graphical image, and delivery information. The method further includes validating the key code, weaving the graphical image into a product to create the customized woven item, and delivering the customized woven item in accordance with the delivery information.

In particular embodiments, the method may further include selling a kit containing the key code or selling the key code using the Internet. Alternate embodiments may include receiving the key code, graphical image, and delivery information electronically or receiving at least one of the key code, graphical image, or delivery information using a web page. In still further embodiments, the method may include receiving a photograph as the graphical image. The method may also include validating the key code using an optical scanner. Alternately, or in addition, the method may include weaving the graphical image into at least one of a blanket or tapestry as the customized woven item. Moreover, particular embodiments of the method may include selecting the customized woven product using a product order number.

In an alternate embodiment within the scope of the present invention, a method for marketing a customized woven item includes associating a key code to a kit and storing the key code for later retrieval. The method further includes displaying the kit and selling at least one of the kit or key code to a customer. In addition the method includes receiving the key code, graphical information, and delivery information and validating the key code. The method also includes weaving the graphical information into a product to create the customized woven item and delivering the customized woven item in accordance with the delivery information.

Another embodiment within the scope of the present invention includes a customized woven item having a container, a key code associated with the container, and instructions for submitting the key code along with a graphical image to a manufacturer for weaving the graphical image into a product to create the customized woven item. In particular embodiments, the customized woven item may further include an order form in the container for documenting a customer's preferences for delivery of the customized woven product. Still further particular embodiments may include a product order number in the container corresponding to the customized woven product.

Those of ordinary skill in the art will better appreciate the features and aspects of such embodiments, and others, upon review of the specification.

### BRIEF DESCRIPTION OF THE DRAWINGS

A full and enabling disclosure of the present invention, including the best mode thereof to one skilled in the art, is set forth more particularly in the remainder of the specification, including reference to the accompanying figures, in which:

FIG. 1 representatively illustrates a gift box provided in accordance with the present subject matter;

FIG. 2 illustrates a plurality of the gift boxes illustrated in FIG. 1 as might be displayed in a retail establishment when placed on sale;

FIG. 3 diagrammatically illustrates a method allowing a recipient of the gift box of FIG. 1 to customize the gift; and

FIG. 4 diagrammatically illustrates an alternate method allowing a recipient of the gift box of FIG. 1 to customize the gift.

Repeat use of reference characters in the present specification and drawings is intended to represent the same or analogous features or elements of embodiments of the invention.

### DETAILED DESCRIPTION OF THE PREFERRED EMBODIMENTS

Reference will now be made in detail to present embodiments of the invention, one or more examples of which are illustrated in the accompanying drawings. Each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents.

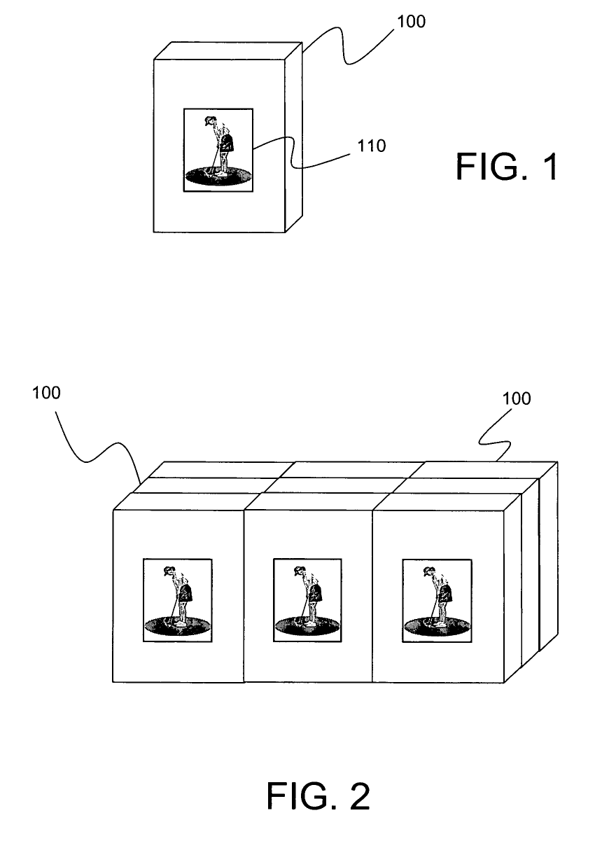

Referring now to the drawings, FIG. 1 illustrates a kit or a gift box 100 sold to a gift shopper through retail stores, the Internet, or other outlets. More particularly, FIG. 2 illustrates that the gift box 100 may be displayed along with similar gift boxes 100 in a store display of a type conventionally used to display generally box-like display items. The gift box 100 may include at least one pictorial representation 110 of an exemplary final product that may ultimately be obtained by a purchaser or recipient of the gift box 100.

As will become more evident upon reading the remainder of the present disclosure, the kit or gift box 100 herein described comprises a form of surrogate gift in that the kit, per se, may not be the ultimate gift. Instead, the recipient may use the kit to obtain the ultimate gift in customized form to suit the recipient's design. It should further be appreciated that while the present disclosure may make reference to the present subject matter as a gift box, it should, of course, be clear that such designation is not intended to limit the present invention to requiring a gift box in any way. The kit may not correspond to a box, per se, but may take the form of an envelope, bag, or other container designed to enclose or contain components necessary to carry out the disclosed subject matter. Moreover, while one of the objectives of the present subject matter is to provide a methodology whereby a customer may purchase a gift for another individual, clearly the customer may purchase the “gift” for the customer's own use.

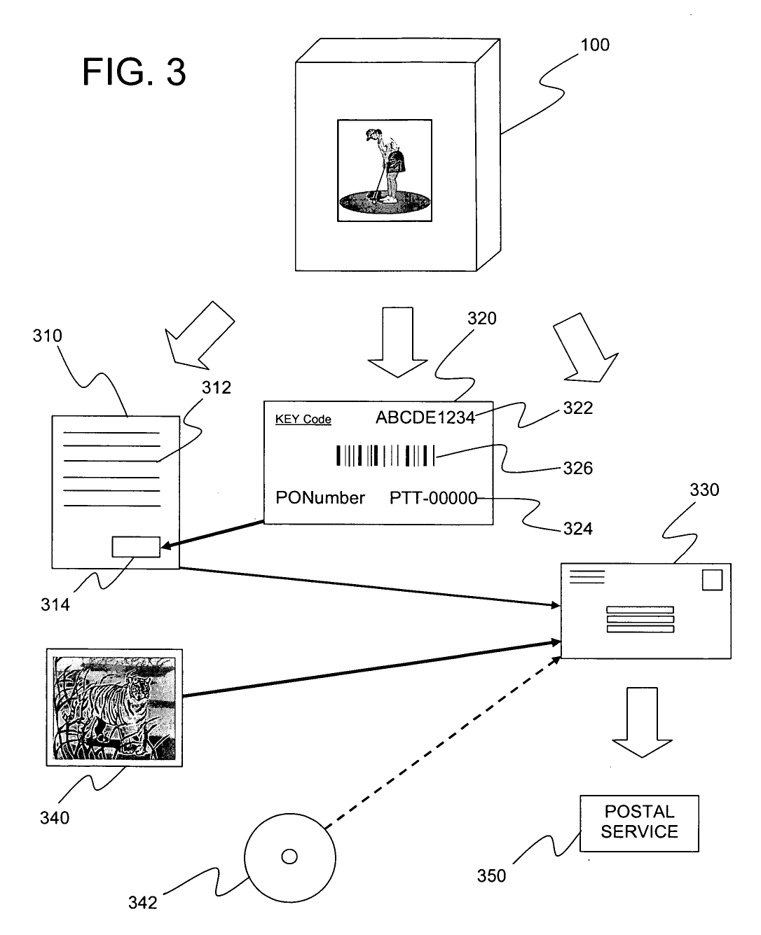

FIG. 3 illustrates an exemplary methodology for completing an order process whereby a recipient of the gift box 100 may customize the gift represented by the gift box 100. In accordance with the present subject matter, the gift box 100 may correspond to a means through which a recipient may receive and customize a prepaid item. In an exemplary embodiment, the customized item ultimately obtained may be a woven blanket or tapestry as will be further described later. It should be kept in mind, however, that the present invention is not limited to woven products, and the customized item may correspond to virtually any item that may be created or modified to correspond to a particular customization desired by the recipient of the gift box 100.

With further reference to FIG. 3, the gift box 100 may be delivered to retail stores or other outlets as a sealed box containing several items. These items may include, but are not limited to, an instruction or order form 310, a key code label 320, and a pre-addressed mailing envelope 330. The gift box 100 may further include additional product information, special offer notices, additional instructions, etc.

Upon opening the gift box 100, a purchaser or recipient may read and follow instructions contained in the gift box 100 and begin the personalization process for the product to be customized by selecting a picture 340 or other graphical image that may be used to personalize or customize the product. In an exemplary embodiment of the present subject matter, the picture 340 of the purchaser's or recipient's own selection may be used as a basis to weave a tapestry, wall hanging, throw, blanket, or other item into which or on which may be produced a reproduction or representation of the picture 340 or other selected graphical image. Other possible final products include canvas reproductions or paintings. The purchaser or recipient may then record information including delivery instructions, such as a mailing address, for delivery of the completed customized tapestry or other customized item.

After completing the instruction or order form 310 and selecting the picture 340 or other graphical image, the purchaser or recipient may affix the key code label 320 containing a key code 322 to a designated portion 314 of the order form 310. The key code label 320 may include the key code 322 in a human readable format, as exemplarily illustrated herein as “ABCDE1234.” In addition to the key code 322, the key code label 320 may also include a Product Order Number (PONumber) 324 representing the particular product, for example a tapestry, corresponding to the intended final gift. Different Product Order Numbers may correspond to different products or different sizes for similar products. For example, the Product Order Number may indicate that a 50 inch by 60 inch tapestry is to be produced. As the gift boxes are assembled by the manufacturer, a record is kept of the specific Product Order Number 324 and matching key code 322 so that such numbers may be validated before processing the customized order.

Following completion of any required entries on the instruction or order form 310, the key code label 320 may be affixed to the designated portion 314 on the order form 310, and the instruction or order form 310 and picture 340 may be enclosed in the envelope 330 and submitted to the postal service 350 for delivery back to the manufacturer for processing. In an alternative embodiment, a purchaser or recipient may submit a compact disk (CD) 342 or other storage medium containing an electronic file corresponding to the picture 340.

With further reference to FIG. 3, it will be noted that the key code label 320 may also include a barcode 326 corresponding to machine readable information that may be optically scanned upon receipt of the instruction or order form 310 by the manufacturer to simplify comparison of the previously stored product order number and key code information for verification purposes prior to completion of the customization process.

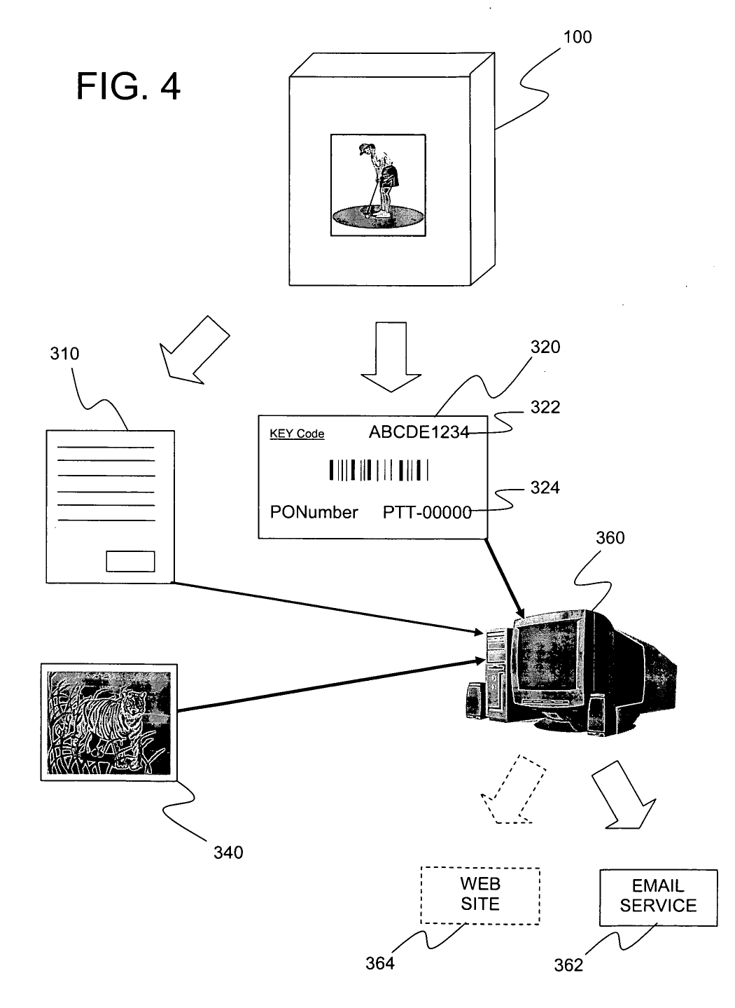

FIG. 4 illustrates an alternative methodology for transmitting required information from a gift box purchaser or recipient to the manufacturer for product customization. In the exemplary embodiment of FIG. 4, the same gift box 100 may be opened to reveal the instruction or order form 310 and key code label 320. Envelope 330 (not illustrated in FIG. 4) may also be included in the gift box 100, but is not employed in this embodiment.

In accordance with this alternate embodiment of the present subject matter, a purchaser or recipient of the gift box 100 may also select the picture 340 or other graphical image for use in customizing the final product, for example a tapestry. In this embodiment, however, the purchaser or recipient may provide the information previously supplied by way of the instruction or order form 310 as well as the picture 340 or other graphical image in electronic form directly to the manufacturer. For example, the purchaser or recipient may transmit by electronic mail (email) files corresponding to the picture 340 as well as other information that otherwise would have been entered on the instruction or order form 310 using a personal or home computer 360 and an electronic mail (email) service 362. In addition, the purchaser or recipient may include in an electronic mail (email) data from the human readable portion of the key code label 320 corresponding to the key code 322 and/or product order number 324. Alternately, the purchaser or recipient may use a web browser directed to an Internet web site 364 to provide the required information, including “uploading” a picture file corresponding to the picture 340 or other graphical image to be used for the item customization.

While the present subject matter has been described in detail with respect to specific embodiments thereof, it will be appreciated that those skilled in the art, upon attaining an understanding of the foregoing may readily produce alterations to, variations of, and equivalents to such embodiments. For example, as previously noted the gift box described may not actually correspond to a box but rather may correspond to an envelope. In another embodiment, that box may actually correspond to a gift card where the key code is hidden by scratch off material. This latter example may be quite suitable where electronic communication with the manufacturer is to be undertaken. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A method for providing a customized woven item, comprising:
a. selling a key code;
b. receiving the key code;
c. receiving a graphical image;
d. receiving delivery information;
e. validating the key code;
f. weaving the graphical image into a product to create the customized woven item; and
g. delivering the customized woven item in accordance with the delivery information.

2. The method of claim 1, further including selling a kit containing the key code.

3. The method of claim 1, further including selling the key code using the Internet.

4. The method of claim 1, further including receiving the key code, graphical image, and delivery information electronically.

5. The method of claim 1, further including receiving at least one of the key code, graphical image, or delivery information using a web page.

6. The method of claim 1, further including receiving a photograph as the graphical image.

7. The method of claim 1, further including validating the key code using an optical scanner.

8. The method of claim 1, further including weaving the graphical image into at least one of a blanket or tapestry as the customized woven item.

9. The method of claim 1, further including selecting the customized woven product using a product order number.

10. A method for marketing a customized woven item, comprising:
a. associating a key code to a kit;
b. storing the key code for later retrieval;
c. displaying the kit;
d. selling at least one of the kit or key code to a customer;
e. receiving the key code;
f. receiving graphical information;
g. receiving delivery information;
h. validating the key code;
i. weaving the graphical information into a product to create the customized woven item; and
j. delivering the customized woven item in accordance with the delivery information.

11. The method of claim 10, further including selling at least one of the kit or key code using the Internet.

12. The method of claim 10, further including receiving the key code, graphical image, and delivery information electronically.

13. The method of claim 10, further including receiving at least one of the key code, graphical image, or delivery information using a web page.

14. The method of claim 10, further including receiving a photograph as the graphical image.

15. The method of claim 10, further including validating the key code using an optical scanner.

16. The method of claim 10, further including weaving the graphical image into at least one of a blanket or tapestry as the customized woven item.

17. The method of claim 10, further including selecting the customized woven product using a product order number.

18. A kit for obtaining a customized item, comprising:
a. a container;
b. a key code associated with the container;
c. instructions for submitting the key code along with a graphical image to a manufacturer for reproducing the graphical image to a product to create the customized item.

19. The kit of claim 18, further including an order form in the container for documenting a customer's preferences for delivery of the customized product.

20. The kit of claim 18, further including a product order number in the container corresponding to the customized product.
